(19) United States
(12) Patent Application Publication
(10) Pub. No.: US 2008/0155434 A1
(43) Pub. Date: Jun. 26, 2008

(54) METADATA ENRICHMENT OF ALERTS IN AN OBJECT-BASED NAVIGATION SYSTEM

(76) Inventor: Ilja Fischer, Bad Schoenborn (DE)

Correspondence Address: KENYON & KENYON LLP, 1500 K STREET N.W., WASHINGTON, DC, 20005, US

(21) Appl. No.: 11/614,533

(22) Filed: Dec. 21, 2006

(51) Int. Cl. G06F 3/048

(52) U.S. Cl. 715/764

(57) ABSTRACT

Embodiments of the present invention provide methods and systems for user interaction with alerts displayed in object-based navigation (OBN) systems. A worklist in an OBN system may display a list of alerts, notifications, system messages, and other similar information enriched with metadata. When a user selects such an alert, a target application specified in the metadata of the alert may be opened in the portal displaying the worklist.

### BACKGROUND

Object-based navigation (OBN) is a way of navigating between components of a complex system, such as a business management system. In such a system, a user accesses functions and components of the system via applications that display instances of business objects. Accessing an instance of a business object via an application makes it possible for a user to manipulate information stored in a business object, for example by viewing and modifying outstanding orders within an instance of a sales orders business object. As part of such a system, a user interface may contain a display of alerts, system messages, and other notifications sent by the system to inform the user of a change in the system, an issue requiring attention, or other similar information. Such alerts often are displayed in a worklist or similar interface, allowing a user to view multiple alerts simultaneously.

When a user receives or views an alert in a portal, the user may want to receive more information or perform an action in the system based on the content of the alert. However, the user must first determine an appropriate application or business object to perform the desired action. This may be difficult or time-consuming, since the user may not know which applications or business objects provide access to the information or operations related to the alert contents. Similarly, there may not be a direct navigation path from the alert to the appropriate application or business object. As such, there is a need for methods and systems allowing such alerts to be associated with appropriate applications, business objects, or other programs and structures.

### BRIEF DESCRIPTION OF THE DRAWINGS

FIG. 1 shows a system and process implementing object-based navigation according to embodiments of the invention.

FIG. 2 shows a system and process implementing object-based navigation according to embodiments of the invention.

FIG. 3 shows a process for creating and using metadata-enriched alerts according to embodiments of the invention.

FIG. 4 shows a system and process implementing object-based navigation according to embodiments of the invention.

### DETAILED DESCRIPTION

Embodiments of the present invention provide methods and systems for user interaction with alerts displayed in object-based navigation (OBN) systems. A “worklist” in an OBN system may display a list of alerts, notifications, system messages, and other similar information enriched with metadata. When a user selects such an alert, a target application specified in the metadata of the alert may be opened in the portal displaying the worklist. In some cases, a portal or worklist may open an application specified by alert metadata without user interaction. Thus a user may easily access information or operations related to the contents of the selected alert.

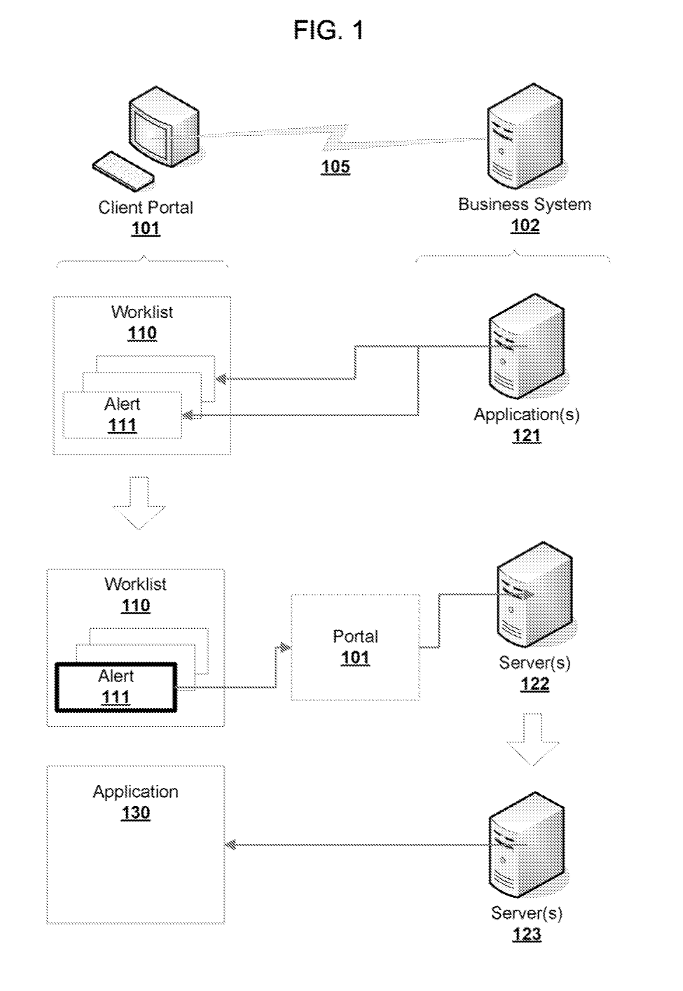

A system and process according to embodiments of the invention are shown in FIG. 1. A user may access a business system 102 via a portal 101. The portal 101 may be a browser-based portal, such as a web browser that displays web pages and web page-based application views. The business system may contain one or more servers, applications, storage media, and other devices. For example, in FIG. 1 there may be multiple servers 122 and 123 within the business system, or a single server may perform the operations described with respect to servers 122 and 123. Similarly, one or more applications 121 may be stored and executed on one or more servers 122 and 123. The specific arrangement and architecture of servers and applications within the business system 102 is immaterial to the present invention unless otherwise specified herein. The portal 101 may be any appropriate interface, such as a web browser for displaying portal pages transmitted by the business system 102. The portal may send information to the business system and receive portal pages and other information from the business system via a communication network 105. The topology, architecture, and related protocols of the communication network 105 are immaterial to the present invention unless otherwise specified herein. The business system may send a portal page including one or more alerts 111 to the portal 101. The alerts may be system messages, notifications, or other information, and may be displayed in a worklist 110 or other appropriate interface. One or more applications 121 within the business system may also send alerts 111. For example, a product shipment application may send an alert to inform a user that an order having an undeliverable address was placed in the system. Each alert 111 may be an object in the OBN system, allowing a user to interact with the alert to perform an operation such as requesting detailed information related to the alert.

When a user selects an alert 111, metadata associated with the selected alert may be transmitted to the business system. A server 122 or 123 may construct a new portal page based on the received metadata associated with the alert 111 selected by the user. The new portal page may contain an interface to a target application 130 that was specified by the metadata of the alert. For example, if the alert relates to an order shipped to a customer, the metadata associated with the alert may specify that an application providing access to the order details and the customer's shipping information should be displayed when the alert is selected. The portal page constructed by the business system may then be transmitted by the business system 123 and displayed by the portal, allowing the user to access the application 130 specified by the alert metadata. In some embodiments, the metadata may first be transmitted to the portal 101. The portal 101 may then request an application interface 130 from the business system based on the metadata associated with the selected alert. For example, if the portal pages are web pages displayed in a web browser, the alert may include scripting commands that direct the web browser to request a web page having a specific application interface from the business system.

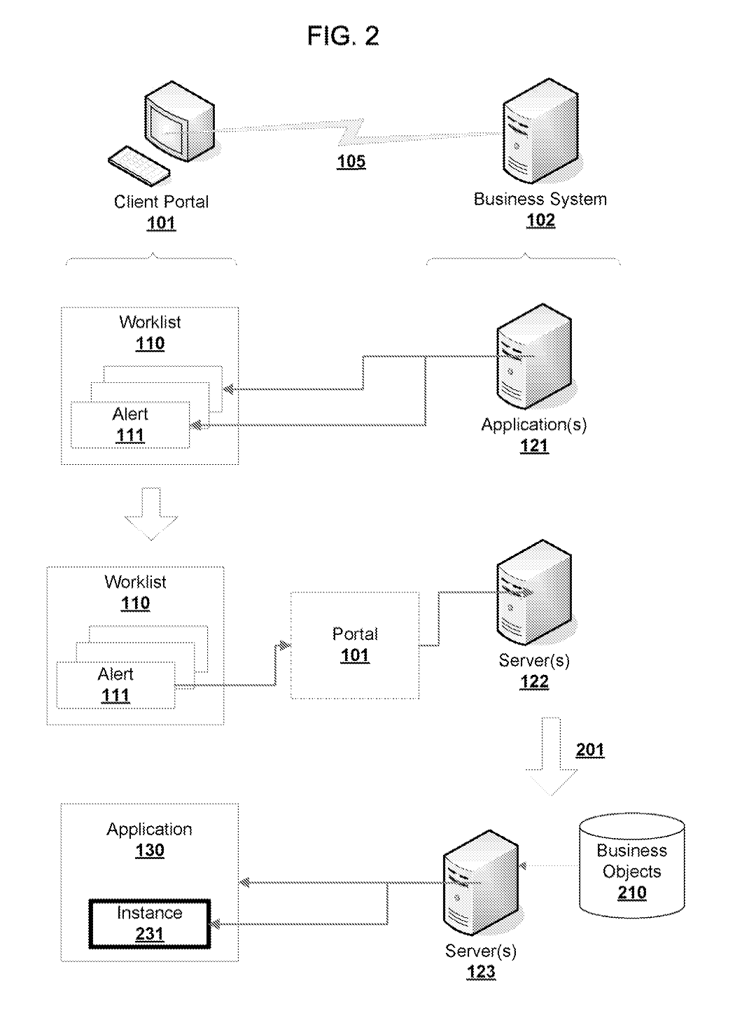

In some embodiments of the invention, the metadata associated with alerts may specify an application view or business object instances that should be displayed in the target application. For example, an alert describing an overdue invoice may have metadata specifying that the target application should be one that allows a user to view an invoice. The metadata may further specify that the target application interface should include instances of the business objects representing the invoice and the business partner to whom the invoice is payable. Such an embodiment is illustrated in FIG. 2. An alert 111 enriched with metadata may be displayed in a portal 101 as previously described. When a user selects the alert, the metadata may be transmitted to the business system 102 and/or the portal 101. If the metadata is transmitted to the portal 101, the portal may request applications, business objects, or other interfaces to be displayed in the portal from the business system. When the business system 122 constructs the portal page to be delivered to the portal, it may select one or more business objects instances to include in the view of the target application 130 based on the metadata. The business objects 210 may be stored in one or more servers, databases, or other appropriate mechanisms within the business system 102. In FIG. 2, the metadata for an alert 111 specifies that a target application 130 with a view displaying a business object instance 231 should be displayed when the alert 111 is selected by a user. Thus, a business system server 123 may construct a portal page having an interface to the target application 130, where the interface includes an instance of the specified business object 231. The metadata may also specify multiple business object instances or views to be shown in the target application. For example, the metadata associated with an alert regarding a customer's order history may specify that instances of the business objects representing the customer, the customer's previous orders, and the customer's payment history should be displayed in a customer relationship target application. Other combinations of target applications, views, and business objects may be specified in the metadata.

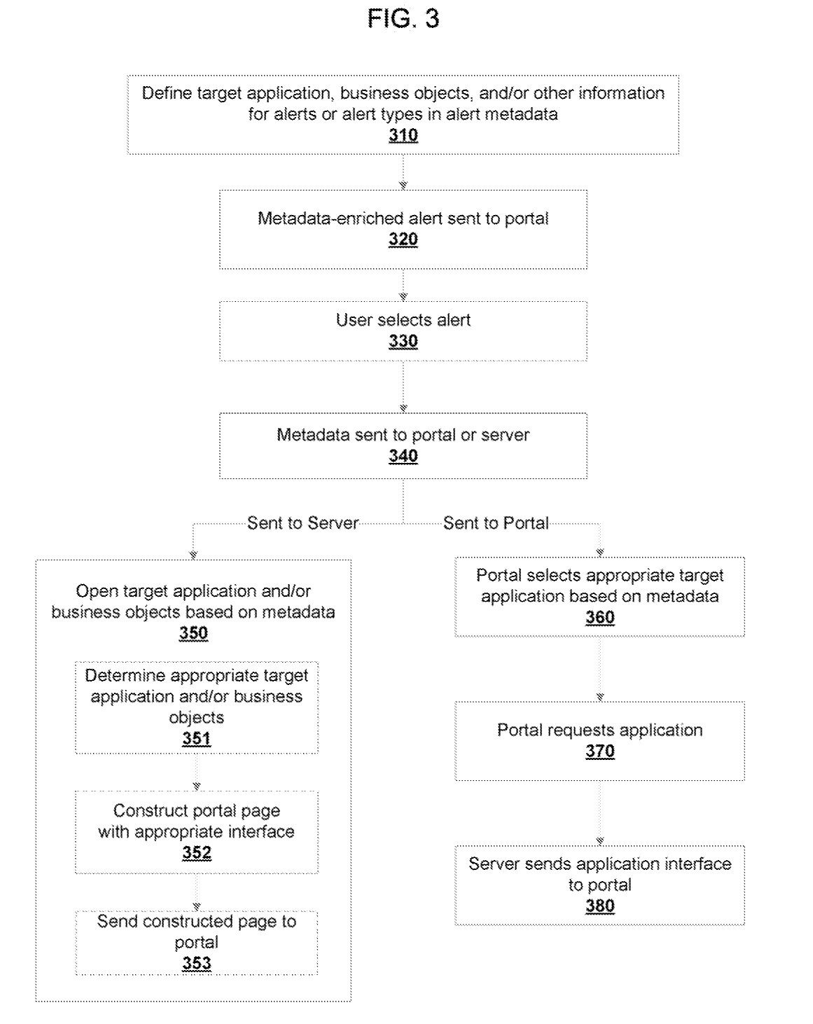

In some embodiments the metadata may specify information other than or in addition to a target application and/or business objects. For example, the metadata may specify a type of business object or a user operation. In FIG. 3, the metadata associated with the alert 111 may specify a user operation, such as adding a new business partner. When the metadata is transmitted to the business system 102, the business system may analyze (201) the metadata to determine if a target application and/or business objects should be opened. For example, if the metadata specifies a user operation, the business system may select a target application and business objects that allow the user to perform the operation specified in the metadata. Similarly, if the metadata specifies a type of business object, the business system may select a target application appropriate to the alert selected by the user, where the application provides an interface to the type of business object specified in the metadata.

In some embodiments, a portal may transmit, request, or otherwise load an application when an alert is received. For example, in FIG. 2 the worklist 110 may not contain any new or unresolved alerts when a first alert 111 is received from the business system 102 or application 121. Upon receiving an alert 111, the portal 101 and/or worklist 110 may request an application, application view, and/or business object instances from the business system 102 based on metadata associated with the alert. The application 130 may then be presented to the user, without requiring user interaction with the alert 111. The application interface may be constructed by the business system as previously described.

The metadata may be defined at the time a business system is created or customized, or it may be created by the business system, for example at the time an alert is sent. A process for creating and using metadata-enhanced alerts is shown in FIG. 3. Metadata specifying target applications and/or business objects may be associated with one or more alerts in a business system 310. When an alert is sent to a portal 320, it may include such metadata. A user may interact with a metadata-enriched alert 330, for example by selecting it from a worklist containing multiple alerts received from the business system. When a user selects an alert having associated metadata, the metadata or information about the metadata may be sent to the portal and/or the business system 340. Similarly, such a transfer of metadata may be made by the portal in response to receiving an alert. The transfer may be made without user interaction. For example, if a worklist is empty when an alert is received, the portal may send metadata to the business system in response to receiving an alert, in order to present an appropriate application interface to the user without requiring user interaction with the alert.

If the metadata is sent to the business system, the business system may open a target application based on the metadata associated with the selected alert 350. The metadata may directly specify a target application and/or business objects, or it may specify a type of business object, a user operation, or other information based on which the business system may select 351 an appropriate target application and/or business objects. A portal page having an interface to the selected application may then be constructed 352 by the business system and sent 353 to the portal. If the metadata is sent to or selected by the portal, the portal may use the metadata to select an appropriate target application 360. The target application may be specified directly by the metadata, or the portal may otherwise determine an appropriate target application. The portal may then request the application from the business system 370. Such a request may be, for example, a request sent by a web browser to the business system. When the business system receives such a request, it may send a portal view 380 having an interface to the requested application to the portal.

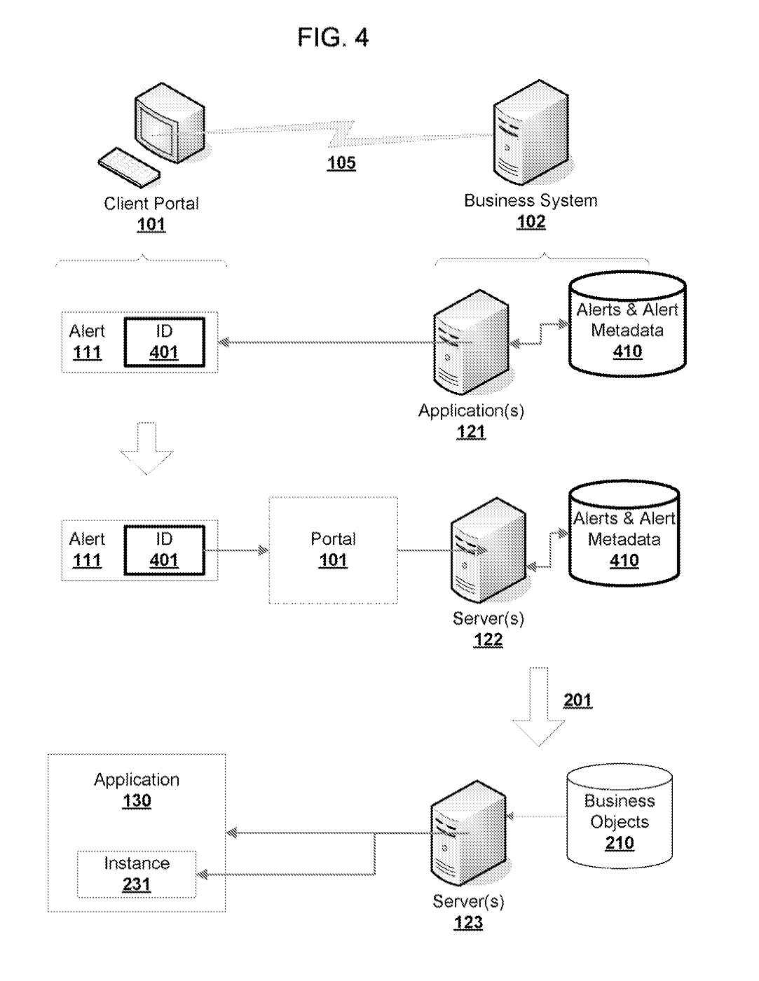

In some embodiments of the invention, the metadata may be stored on one or more servers within a business system. When an application or other program in the business system sends an alert to a portal, the alert may contain an identifier that is associated with metadata in the business system. For example, the business system may contain a record of various alert identifiers, with a target application or other metadata associated with each alert identifier. Other information, such as a business object or specific application view may also be associated with an alert identifier. An example of such a system and a related process is shown in FIG. 4. A user may access a business system 102 via a portal 101 as previously described. One or more alerts with associated metadata 410 may be stored in the business system. The metadata-enriched alerts may have been previously defined by a user or developer, or they may be created by the business system. When an application or other program 121 sends an alert 111 to a portal, the alert may include an alert identifier 401. The identifier may be, for example, a unique identifier specifying the alert 111, a general identifier specifying the type of alert that was sent, or any other identifier. When a user or portal selects or interacts with the alert 111, the identifier 401 may be sent to the business system. The identifier may be sent by the portal 101, for example as part of a request sent by a web browser. When a server 122 in the business system receives such a request, it may use the alert metadata 410 to determine an appropriate target application interface. The business system may then construct 201 a portal view containing an interface 130 to the target application. The portal view may also contain instances 231 of business objects 210 specified by the metadata 410. The metadata may specify other aspects of the portal view created by the business system. For example, metadata for an alert may specify a target application view, one or more business objects, and an operation. When such an alert is selected by a user, the business system may construct a portal view having an the target application view, instances of the specified business objects, and that allows a user to perform the specified operation. Various alerts may have more or less information specified in the metadata associated with each alert.

Although the present invention has been described with reference to particular examples and embodiments, it is understood that the present invention is not limited to those examples and embodiments. The present invention as claimed therefore includes variations from the specific examples and embodiments described herein, as will be apparent to one of skill in the art.

What is claimed is:

1. A method for object-based navigation comprising, at a server:
sending an alert to a portal, the alert having metadata specifying at least one of a target application, an operation, or a target application view;
in response to a request received from the portal after a user interaction with the alert, constructing a portal view having an interface to at least one item specified in the metadata; and
sending the portal view to the portal.

2. The method of claim 1, wherein at least some of the metadata is sent to the portal with the alert.

3. The method of claim 1, wherein the metadata is stored on the sever.

4. The method of claim 1, the metadata further specifying a business object, and the portal view further comprising an instance of the business object.

5. A method for object-based navigation comprising, at a portal;
receiving an alert having metadata specifying at least one of a target application or an operation;
displaying the alert in a worklist;
in response to a user interaction with the alert, determining a target application;
sending a request specifying the target application to the business system; and
receiving an interface to the target application from the business system.

6. The method of claim 5 wherein the portal constructs a view for the application interface received from the business system, and wherein the view is based on the metadata.

7. A method for object-based navigation comprising, at a server:
sending an alert with an identifier to a portal, wherein the identifier is associated with metadata specifying at least one of a target application, an operation, or a target application view;
in response to a request containing the identifier received from the portal, selecting the metadata associated with the identifier;
constructing a portal view having an interface to at least one item specified by the metadata; and
sending the portal view to the portal.

8. The method of claim 7 wherein the request is sent by the portal in response to receiving the alert.

9. The method of claim 7, the metadata further specifying a business object, and the portal view further comprising an instance of the business object.

10. A machine-readable medium containing program instructions for execution on a processor, which when executed cause the processor to perform:
sending an alert with an identifier to a portal, wherein the identifier is associated with metadata specifying at least one of a target application, an operation, or a target application view;
in response to a request containing the identifier received from the portal, selecting the metadata associated with the identifier;
constructing a portal view having an interface to at least one item specified by the metadata; and
sending the portal view to the portal.

11. The machine-readable medium of claim 10, the metadata further specifying a business object, wherein the processor is further to perform sending an instance of the business object in the portal view.

12. A navigation method for portal sessions, comprising, at a server:
receiving a resource request from a client representing user interactivity with an alert within a portal session,
analyzing metadata associated with the alert to determine at least one of a target application, a target application view, or a business object;
generating a new portal page having an interface to the at least one of a target application, a target application view, or a business object; and
transmitting the page to the client.

13. A system comprising:
storage for a plurality of alerts for transmission to a browser-based portal;
storage for metadata of at least one of the plurality of alerts; and
a target application interface for transmission to a browser-based portal;
wherein the metadata of at least one of the plurality of alerts specifies the target application interface.

14. The system of claim 13, further comprising a plurality of business objects, wherein the metadata of at least one of the plurality of alerts specifies at least one business object.
